(19) United States
(12) Patent Application Publication
(10) Pub. No.: US 2025/0173968 A1
(43) Pub. Date: May 29, 2025

(54) METHOD AND DEVICE FOR VOXEL-WISE 3D MESH TEXTURE PATCH GENERATION

(71) Applicant: Electronics and Telecommunications Research Institute, Daejeon (KR)

(72) Inventors: Ji Hoon DO, Daejeon (KR); Soo Woong KIM, Daejeon (KR); Gun BANG, Daejeon (KR); Seong Jun BAE, Daejeon (KR); Jin Ho LEE, Daejeon (KR); Ha Hyun LEE, Daejeon (KR); Jung Won KANG, Daejeon (KR)

(21) Appl. No.: 18/963,323

(22) Filed: Nov. 27, 2024

(30) Foreign Application Priority Data
Nov. 29, 2023 (KR) 10-2023-0170134
Nov. 20, 2024 (KR) 10-2024-0166203

(51) Int. Cl. G06T 17/20; G06T 15/04; G06T 15/08

(52) U.S. Cl. CPC G06T 17/20; G06T 15/04; G06T 15/08

(57) ABSTRACT

The present disclosure relates to a method and device for generating a voxel-by-voxel three-dimensional mesh texture patch. A method for generating a voxel-wise texture patch according to an embodiment of the present disclosure may comprise: generating a truncated signed distance function (TSDF) volume based on a multi-view image; generating and allocating a texture patch for each voxel in the TSDF volume; and performing optimization of the texture patch based on joint learning for the texture patch and a specific decoder to which the texture patch is input.

### CROSS-REFERENCE TO RELATED APPLICATIONS

This application claims the benefit of earlier filing date and right of priority to Korean Application No. 10-2023-0170134, filed on Nov. 29, 2023, and Korean Application No. 10-2024-0166203, filed on Nov. 20, 2024, the contents of which are all hereby incorporated by reference herein in their entirety.

### TECHNICAL FIELD

The present disclosure relates to a method and apparatus for generating a voxel-wise three-dimensional (3D) mesh texture patch based on machine learning that performs optimization for randomly sized texture patches assigned voxel-wise within a truncated signed distance function (TSDF) volume restored from a multi-view image.

### BACKGROUND

A conventional texture map image is generated by performing two-dimensional (2D) mapping (e.g., UV-parameterization) on a three-dimensional (3D) mesh generated through a TSDF volume restored from a multi-view image, dividing (i.e., fragmenting) the mesh surface into a large number of regions, mapping it to a 2D plane (e.g., UV map), and storing the texture on the 2D plane to generate a texture map image.

At this time, since the 2D mapping operation is very complex and causes a large burden on hardware, especially in a scene image with a high resolution, a method for generating a texture patch to be applied to a 3D mesh without a 2D mapping operation is required.

### SUMMARY

The technical object of the present disclosure is to provide a method and apparatus for efficiently generating a voxel-wise 3D mesh texture patch based on machine learning.

The technical objects to be achieved by the present disclosure are not limited to the above-described technical objects, and other technical objects which are not described herein will be clearly understood by those skilled in the pertinent art from the following description.

A method for generating a voxel-wise texture patch according to an aspect of the present disclosure may comprise: generating a truncated signed distance function (TSDF) volume based on a multi-view image; generating and allocating a texture patch for each voxel in the TSDF volume; and performing optimization of the texture patch based on joint learning for the texture patch and a specific decoder to which the texture patch is input.

An apparatus of generating a voxel-wise texture patch according to an additional aspect of the present disclosure may comprise at least one processor and at least one memory, wherein the processor may be configured to: generate a truncated signed distance function (TSDF) volume based on a multi-view image; generate and allocate a texture patch for each voxel in the TSDF volume; and perform optimization of the texture patch based on joint learning for the texture patch and a specific decoder to which the texture patch is input.

As one or more non-transitory computer readable medium storing one or more instructions, the one or more instructions may be executed by one or more processors and control an apparatus for generating a voxel-wise texture patch to: generate a truncated signed distance function (TSDF) volume based on a multi-view image; generate and allocate a texture patch for each voxel in the TSDF volume; and perform optimization of the texture patch based on joint learning for the texture patch and a specific decoder to which the texture patch is input.

In various aspects of the present disclosure, voxel-wise texture patches may be packed into a single texture map.

Additionally, in various aspects of the present disclosure, a voxel-wise texture patch may have a size of M×N based on preset M and N values, where M and N are integers greater than or equal to 1.

Additionally, in various aspects of the present disclosure, the specific decoder may be based on a tiny network constructed through connections of multi-layer perceptrons (MLPs).

Additionally, in various aspects of the present disclosure, features of generating a rendered image by performing mesh-based sampling on decoded texture patches; and calculating a distortion between the rendered image and an original image may be additionally comprised. Herein, the calculated distortion may be used as a loss function for iterative optimization related to texture patch generation and rendering. In this regard, the rendered image may be generated using a differentiable renderer based on interpolation. In addition, the distortion may be a compression distortion calculated by performing rendering at multiple viewpoints in the multi-view image.

Additionally, in various aspects of the present disclosure, a viewpoint direction on the texture patch domain may be additionally applied for joint learning related to the optimization of the texture patch. In this regard, the viewpoint direction on the texture patch domain may be generated through an iterative optimization that calculates the distortion between a viewpoint direction calculated for a specific viewpoint and a viewpoint direction generated by allocating and rendering a texture patch with the same size of three channels for each voxel.

The features briefly summarized above regarding the present disclosure are merely exemplary aspects of the detailed description of the present disclosure that follows and do not limit the scope of the present disclosure.

According to the present disclosure, a method and apparatus for efficiently generating a voxel-wise 3D mesh texture patch based on machine learning may be provided.

According to the present disclosure, there is a technical effect in which the synthesis of all or part of an image for a desired arbitrary point in time may be efficiently performed in real time through a hardware/rendering-friendly texture mapping method.

According to the present disclosure, there is a technical effect of improving the efficiency of hardware operation and calculation in generating a voxel-wise 3D mesh texture patch.

Effects achievable by the present disclosure are not limited to the above-described effects, and other effects which are not described herein may be clearly understood by those skilled in the pertinent art from the following description.

### BRIEF DESCRIPTION OF THE DRAWINGS

FIG. 1 illustrates coordinate transformation for texturing between a multi-view image, a UV texture map, and a rendered image according to a conventional method.

FIG. 2 illustrates a method of generating a high compression ratio texture map according to a conventional method.

FIG. 3 illustrates an overall flowchart related to texture patch generation according to an embodiment of the present disclosure.

FIG. 4 illustrates the structure of a tiny network for decoding a texture patch according to an embodiment of the present disclosure.

FIG. 5 illustrates a packed texture map generated according to an embodiment of the present disclosure.

FIG. 6 illustrates an operational flowchart of a method for generating a voxel-wise texture patch according to an embodiment of the present disclosure.

FIG. 7 is a block diagram illustrating a device according to an embodiment of the present disclosure.

### DETAILED DESCRIPTION

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from other element. For example, without getting out of a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

In the present disclosure, a machine learning-based voxel-wise 3D texture patch generation method and device that perform optimization for randomly sized texture patches assigned to each voxel within a TSDF volume restored from a multi-view image are proposed through specific examples.

In the conventional method, UV parameterization needs to be performed on the generated 3D mesh in order to generate a mesh texture map supporting the required compression ratio.

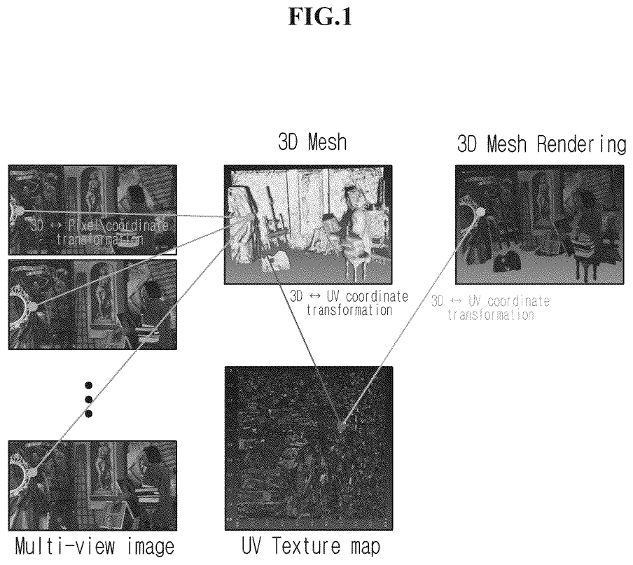

FIG. 1 illustrates coordinate transformation for texturing between a multi-view image, a UV texture map, and a rendered image according to a conventional method.

Referring to FIG. 1, the 3D mesh image may correspond to the result of performing 3D restoration through transformation between 3D and pixel coordinates in a multi-view image. The 3D mesh rendering may correspond to the result of texture mapping. In addition, the UV texture map may correspond to the result of performing UV parameterization and texture map generation through transformation between 3D and UV coordinates based on the 3D mesh and 3D mesh rendering.

In other words, the method of generating a single texture map image for mesh texturing from a multi-view image may correspond to a method of extracting texture values associated with a point on the surface of a 3D model from a multi-view image, converting it into a single texture value that may express an optimal rendering result, and storing it in a texture map.

However, UV parameterization requires a large amount of computation and may place a large burden on hardware. In particular, the burden is very large for complex and high-resolution scene images, and even if fragmentation is performed to resolve this, there is still a problem of high complexity and deterioration of rendering quality.

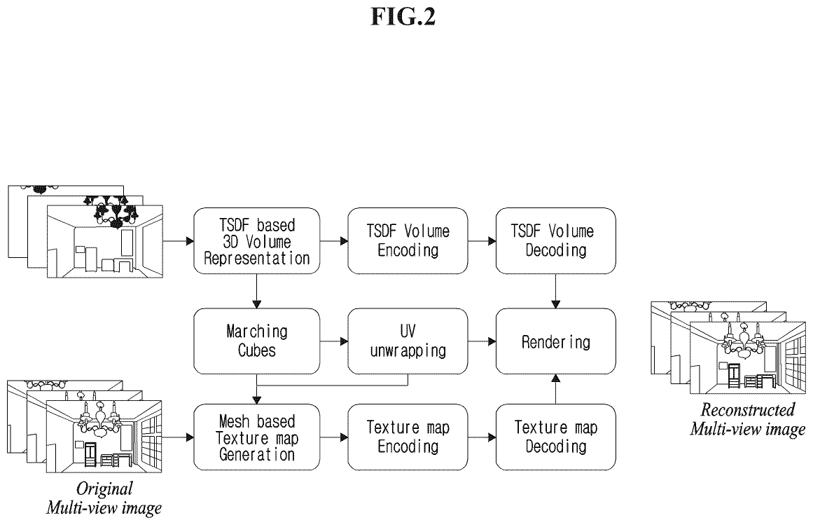

FIG. 2 illustrates a method of generating a high compression ratio texture map according to a conventional method.

Referring to FIG. 2, in the case of the conventional method, since the complexity is excessively high, problems such as high energy consumption, inaccessibility to arbitrary coordinates, inefficiency in GPU use, and latency between CPU and GPU may occur.

Considering these points, conventional methods may have many limitations for industrial use.

Considering the above-mentioned problems, the present disclosure proposes a method and device for generating a texture patch to be applied to a 3D mesh without performing a mapping operation onto a 2D plane.

In the case of the proposed method of the present disclosure, not only may rendering be performed in real time without delay between hardware, but also high-quality arbitrary viewpoints may be synthesized. In addition, in order to improve network performance, the data obtained by performing a method of mapping the viewpoint direction of an image to a texture patch may be utilized as additional information for network learning.

Based on this approach, the proposed method of the present disclosure enables generation of texture patches that are renderer- and hardware-friendly/robust.

Below, a method is specifically described for assigning a learnable texture patch of arbitrary size to each voxel in a generated TSDF volume, and performing joint learning of a differentiable renderer (e.g., a differentiable mesh renderer) and a small learning network (e.g., a Tiny Network) based on the same, thereby making the entire rendering process differentiable without generating a separate UV map.

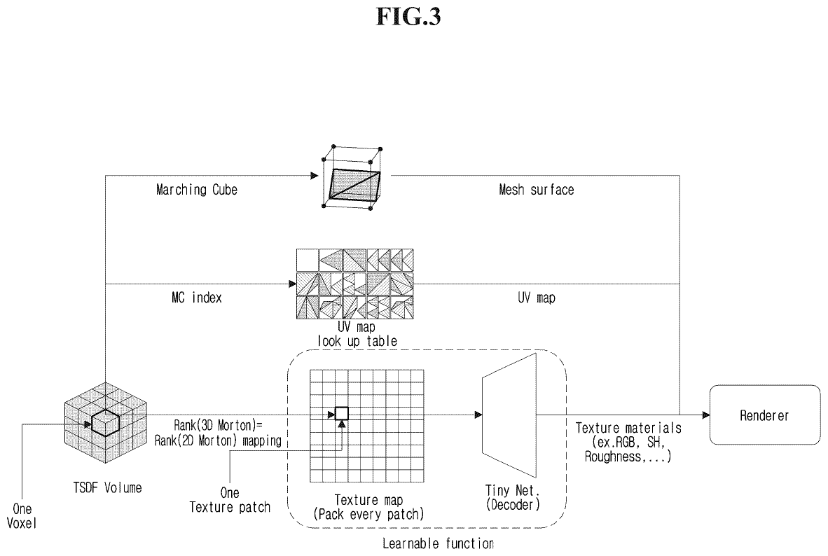

FIG. 3 illustrates an overall flowchart related to texture patch generation according to an embodiment of the present disclosure.

Referring to FIG. 3, a TSDF volume may be generated through a multi-view image, and the TSDF volume may be constructed with a number of voxels.

At this time, a learnable texture patch of a certain size may be assigned to each voxel in the generated TSDF volume.

Optimization for texture patches may be performed by jointly learning the assigned texture patches with a tiny network. Here, the tiny network may perform the function/role of a decoder.

At this time, the size of the texture patch may be M×N, where both M and N may be integers greater than or equal to 1. In addition, for ease of learning, the texture patches for each voxel may be packed into one texture map.

When using this method, the process of compressing textures within an existing GPU may be used, so that random access is possible and parallel compression may be performed. Based on this, hardware efficiency improvement and hardware operation acceleration may be easily performed.

Additionally, distortion may be measured by comparing the rendered image with the original image, i.e., the result of rendering texture patches for all or some voxels.

In addition, the method and device proposed in the present disclosure may be designed to learn by iterative optimization the entire process related to texture patch generation using a differentiable renderer.

With respect to the renderer of the proposed method of the present disclosure, a texture patch corresponding to a voxel of a rendering viewpoint (viewing direction) may be calculated for each pixel. Based on this, rendering may be performed through sampling (e.g., texture/mesh sampling) using an interpolation function (e.g., bi-linear function, nearest function, etc.) from the coordinates stored in the pixel to the texture patch.

In this regard, a differentiable renderer may be constructed through interpolation-based differentiable renderer.

Additionally, texture patches existing per voxel may be decoded via a tiny network (which acts as a decoder in the proposed method of the present disclosure).

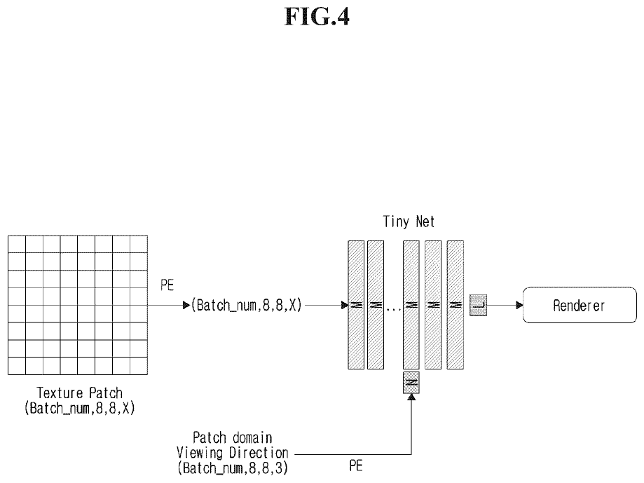

FIG. 4 illustrates the structure of a tiny network for decoding a texture patch according to an embodiment of the present disclosure.

Referring to FIG. 4, a tiny network may be configured with a connection of (simple) multi-layer perceptrons (MLPs).

In FIG. 4, X, M, and L are all integers greater than or equal to 1, N is a multiple of 3, and Y may be an integer that is a multiple of X.

An image Ĩᵥ at rendering viewpoint v may be rendered by sampling the decoded texture patches onto the mapped mesh surface through a tiny network. At this time, the number of channels of the decoded texture patches may be set differently based on the desired/required information.

Based on the rendering procedure, the distortion between the original image Iᵥ and the rendered image Ĩᵥ corresponding to viewpoint v is calculated, and the distortion may be used as a loss function for iterative optimization.

The following Equation 1 illustrates the distortion between the original image and the rendered image according to the proposed method of the present disclosure.

$$D ( \tilde{X} ) = \frac{1}{V} {\sum }_{v = 1}^{V} {‖ {I}_{v} - {\tilde{I}}_{v} ‖}_{2}^{2} \qquad [ Equation 1 ]$$

$$Or$$

$$D ( \tilde{X} ) = \frac{1}{V} {\sum }_{v = 1}^{V} ‖ {I}_{v} - {\tilde{I}}_{v} ‖$$

With respect to the distortion described above, compression distortion may also be calculated and applied by rendering all V viewpoints of the multi-view image.

Additionally or alternatively, as illustrated in FIG. 4, the patch domain viewing direction may be additionally applied to a tiny network to improve the performance of the method proposed in the present disclosure.

That is, the patch domain viewpoint direction may be used as additional information for performance improvement, and an appropriate/suitable patch domain viewpoint direction may be used for learning at each learning viewpoint.

In this regard, the patch domain viewpoint direction may be generated through iterative optimization by computing the viewpoint direction Dᵥ corresponding to the viewpoint v, and calculating the distortion between the generated viewpoint directions \tilde{D}ᵥ by allocating and rendering a texture patch with the same size of 3-channels per voxel.

The following Equation 2 illustrates the distortion in the viewpoint direction according to the proposed method of the present disclosure.

$$D ( {\tilde{Y}}_{v} ) = ‖ {D}_{v} - {\tilde{D}}_{v} ‖ \qquad [ Equation 2 ]$$

$$Or$$

$$D ( \tilde{X} ) = {‖ {D}_{v} - {\tilde{D}}_{v} ‖}_{2}^{2}$$

Additionally, with respect to the method proposed in the present disclosure, in the case of a 3D mesh restored from an actual multi-view image, there may be cases where not all surfaces present in the image are restored.

In this case, when rendering a 3D mesh, unrendered pixel areas (e.g. holes) may occur.

When measuring compression distortion to avoid optimization failure due to non-rendered pixel areas (e.g., holes), a binary mask that may represent the hole pixel areas may be used.

The compression distortion when the mask is used may be expressed as in Equation 3.

$$D ( \tilde{X} ) = \frac{1}{V} {\sum }_{v = 1}^{V} {‖ {M}_{v} \cdot ( {I}_{v} - {\tilde{I}}_{v} ) ‖}_{2}^{2} \qquad [ Equation 3 ]$$

$$Or$$

$$D ( \tilde{X} ) = \frac{1}{V} {\sum }_{v = 1}^{V} ‖ {M}_{v} \cdot ( {I}_{v} - {\tilde{I}}_{v} ) ‖$$

In Equation 3, My represents a binary mask of the image size where the rendering valid area of viewpoint v is expressed as 1 and the empty area is expressed as 0.

When using Equation 3, distortion may be measured only for pixels that are not in non-rendered pixel areas (e.g., holes).

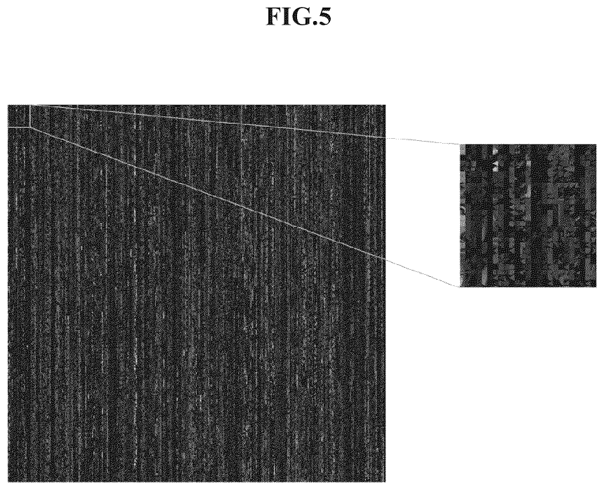

FIG. 5 illustrates a packed texture map generated according to an embodiment of the present disclosure.

Referring to FIG. 5, a case may be considered where a texture patch of size 16×16 is allocated to each voxel.

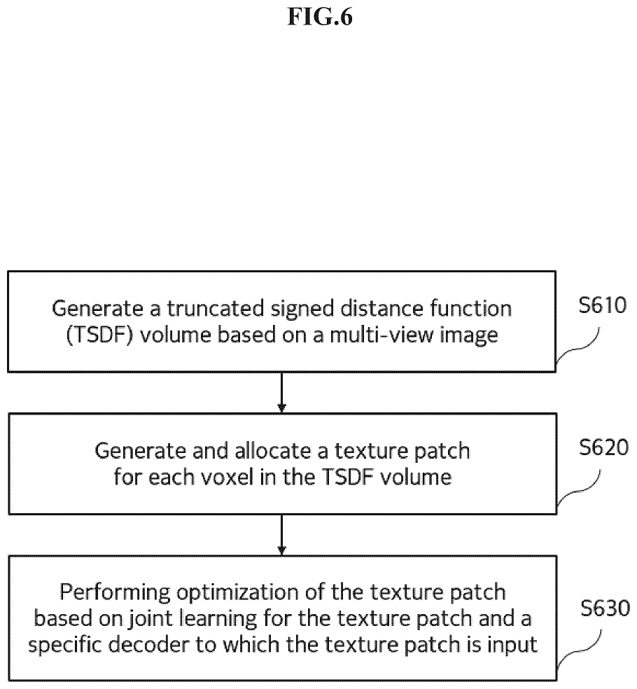

FIG. 6 illustrates an operational flowchart of a method for generating a voxel-wise texture patch according to an embodiment of the present disclosure.

The operation described in FIG. 6 may be based on the method and device for generating a voxel-wise 3D mesh texture patch described through FIGS. 1 to 5 in the present disclosure.

First, a truncated signed distance function (TSDF) volume may be generated based on a multi-view image (step S610).

Afterwards, a texture patch (learnable texture patch) may be generated and assigned to each voxel within the TSDF volume (step S620).

According to an embodiment of the present disclosure, voxel-wise texture patches may be packed into one texture map. In addition, the voxel-wise texture patch has a size of M×N based on preset M values and N values, wherein the M values and N values may be integers greater than or equal to 1.

Afterwards, optimization of the texture patch may be performed based on joint learning for the assigned texture patch and a specific decoder that receives the texture patch as input (step S630).

According to an embodiment of the present disclosure, a specific decoder may be based on a tiny network constructed through a connection of multi-layer perceptrons (MLPs).

Additionally or alternatively, according to an embodiment of the present disclosure, an operation of performing mesh-based sampling on decoded texture patches to generate a rendered image and an operation of computing a distortion between the rendered image and the original image may be additionally performed. The computed distortion may be used as a loss function for iterative optimization related to texture patch generation and rendering.

In this regard, the rendered image may be generated/constructed using a differentiable renderer based on interpolation.

Additionally, the distortion may be a compression distortion calculated by performing rendering at multiple viewpoints in the multi-view image.

Additionally or alternatively, according to an embodiment of the present disclosure, a viewpoint direction on a texture patch domain may be additionally applied for joint learning related to the optimization of the texture patch. In this regard, the viewpoint direction on the texture patch domain may be generated through an iterative optimization in which a distortion is calculated between a viewpoint direction calculated for a specific viewpoint and a viewpoint direction generated by allocating and rendering a texture patch having the same size of 3 channels per voxel.

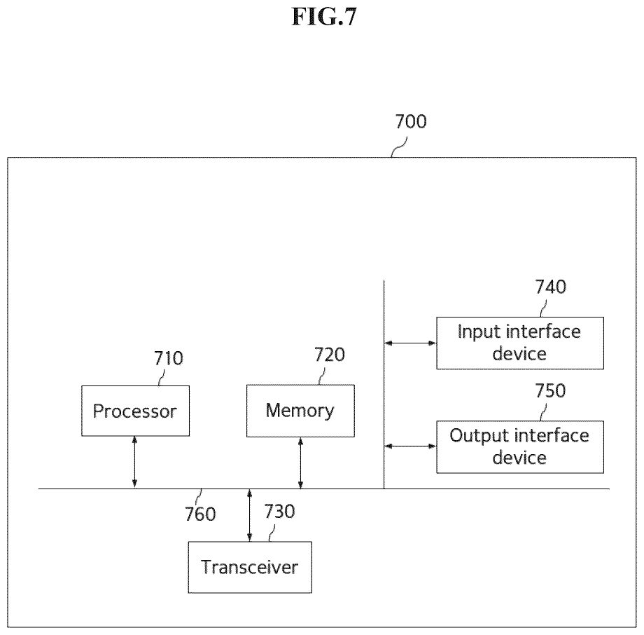

FIG. 7 is a block diagram illustrating an apparatus according to an embodiment of the present disclosure.

Referring to FIG. 7, a device (700) may represent a device in which a method for generating a voxel-wise three-dimensional (3D) mesh texture patch described in the present disclosure is implemented.

The device 700 may include at least one of a processor 710, a memory 720, a transceiver 730, an input interface device 740, and an output interface device 750. Each of the components may be connected by a common bus 760 to communicate with each other. In addition, each of the components may be connected through a separate interface or a separate bus centering on the processor 710 instead of the common bus 760.

The processor 710 may be implemented in various types such as an application processor (AP), a central processing unit (CPU), a graphic processing unit (GPU), etc., and may be any semiconductor device that executes a command stored in the memory 720. The processor 710 may execute a program command stored in the memory 720. The processor (710) may be configured to implement the method for generating a voxel-wise 3D mesh texture patch described based on FIGS. 1 to 6 described above.

And/or, the processor 710 may store a program command for implementing at least one function for the corresponding modules in the memory 720 and may control the operation described based on FIGS. 1 to 6 to be performed.

The memory 720 may include various types of volatile or non-volatile storage media. For example, the memory 720 may include read-only memory (ROM) and random access memory (RAM). In an embodiment of the present disclosure, the memory 720 may be located inside or outside the processor 710, and the memory 720 may be connected to the processor 710 through various known means.

The transceiver 730 may perform a function of transmitting and receiving data processed/to be processed by the processor 710 with an external device and/or an external system.

The input interface device 740 is configured to provide data to the processor 710.

The output interface device 750 is configured to output data from the processor 710.

According to the present disclosure, a method and device for efficiently generating a voxel-wise 3D mesh texture patch based on machine learning may be provided.

According to the present disclosure, there is a technical effect in which the synthesis of all or part of an image for a desired arbitrary viewpoint may be efficiently performed in real time through a hardware/rendering-friendly texture mapping method.

According to the present disclosure, there is a technical effect of improving the efficiency of hardware operation and calculation in generating a voxel-wise 3D mesh texture patch.

The components described in the example embodiments may be implemented by hardware components including, for example, at least one digital signal processor (DSP), a processor, a controller, an application-specific integrated circuit (ASIC), a programmable logic element, such as an FPGA, GPU other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers.

A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors. Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment.

Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Accordingly, it is intended that this disclosure embrace all other substitutions, modifications and variations belong within the scope of the following claims.

What is claimed is:

1. A method for generating a voxel-wise texture patch, the method comprising:
generating a truncated signed distance function (TSDF) volume based on a multi-view image;
generating and allocating a texture patch for each voxel in the TSDF volume; and
performing optimization of the texture patch based on joint learning for the texture patch and a specific decoder to which the texture patch is input.

2. The method of claim 1,
wherein voxel-wise texture patches are packed into a single texture map.

3. The method of claim 1,
wherein a voxel-wise texture patch has a size of M×N based on preset M and N values, where M and N are integers greater than or equal to 1.

4. The method of claim 1,
wherein the specific decoder is based on a tiny network constructed through connections of multi-layer perceptrons (MLPs).

5. The method of claim 1, further comprising:
generating a rendered image by performing mesh-based sampling on decoded texture patches; and
calculating a distortion between the rendered image and an original image,
wherein the calculated distortion is used as a loss function for iterative optimization related to texture patch generation and rendering.

6. The method of claim 5,
wherein the rendered image is generated using a differentiable renderer based on interpolation.

7. The method of claim 5,
wherein the distortion is a compression distortion calculated by performing rendering at multiple viewpoints in the multi-view image.

8. The method of claim 1,
wherein a viewpoint direction on the texture patch domain is additionally applied for joint learning related to the optimization of the texture patch.

9. The method of claim 8,
wherein the viewpoint direction on the texture patch domain is generated through an iterative optimization that calculates the distortion between a viewpoint direction calculated for a specific viewpoint and a viewpoint direction generated by allocating and rendering a texture patch with the same size of three channels for each voxel.

10. An apparatus of generating a voxel-wise texture patch, the apparatus comprising:
at least one processor and at least one memory,
wherein the processor is configured to:
generate a truncated signed distance function (TSDF) volume based on a multi-view image;
generate and allocate a texture patch for each voxel in the TSDF volume; and
perform optimization of the texture patch based on joint learning for the texture patch and a specific decoder to which the texture patch is input.

11. The apparatus of claim 10,
wherein voxel-wise texture patches are packed into a single texture map.

12. The apparatus of claim 10,
wherein a voxel-wise texture patch has a size of M×N based on preset M and N values, where M and N are integers greater than or equal to 1.

13. The apparatus of claim 10,
wherein the specific decoder is based on a tiny network constructed through connections of multi-layer perceptrons (MLPs).

14. The apparatus of claim 10,
wherein the processor is configured to:
generate a rendered image by performing mesh-based sampling on decoded texture patches; and
calculate a distortion between the rendered image and an original image,
wherein the calculated distortion is used as a loss function for iterative optimization related to texture patch generation and rendering.

15. The apparatus of claim 14,
wherein the rendered image is generated using a differentiable renderer based on interpolation.

16. The apparatus of claim 14,
wherein the distortion is a compression distortion calculated by performing rendering at multiple viewpoints in the multi-view image.

17. The apparatus of claim 10,
wherein a viewpoint direction on the texture patch domain is additionally applied for joint learning related to the optimization of the texture patch.

18. The apparatus of claim 17,
wherein the viewpoint direction on the texture patch domain is generated through an iterative optimization that calculates the distortion between a viewpoint direction calculated for a specific viewpoint and a viewpoint direction generated by allocating and rendering a texture patch with the same size of three channels for each voxel.

19. One or more non-transitory computer readable medium storing one or more instructions,
wherein the one or more instructions are executed by one or more processors and control an apparatus for generating a voxel-wise texture patch to:
generate a truncated signed distance function (TSDF) volume based on a multi-view image;
generate and allocate a texture patch for each voxel in the TSDF volume; and
perform optimization of the texture patch based on joint learning for the texture patch and a specific decoder to which the texture patch is input.

20. The computer readable medium of claim 19,
wherein the one or more instructions are executed by one or more processors and control an apparatus for generating a voxel-wise texture patch to:
generate a rendered image by performing mesh-based sampling on decoded texture patches; and
calculate a distortion between the rendered image and an original image,
wherein the calculated distortion is used as a loss function for iterative optimization related to texture patch generation and rendering.
